(19) United States
(12) Patent Application Publication
(10) Pub. No.: US 2012/0007957 A1
(43) Pub. Date: Jan. 12, 2012

(54) Method for calibrating a measuring system and a measuring station for vehicle measurement

(76) Inventors: Steffen ABRAHAM, Hildesheim (DE); Jonas BOSTELMANN, Hannover (DE)

(21) Appl. No.: 13/170,853

(22) Filed: Jun. 28, 2011

(30) Foreign Application Priority Data
Jul. 7, 2010 (DE) 102010031056.5

(51) Int. Cl. H04N 13/02

(52) U.S. Cl. 348/47; 348/E13.074

(57) ABSTRACT

A method for calibrating a measuring system and a measuring station for a vehicle measurement, having a road surface and at least two measuring heads, each measuring head having at least one lighting device and at least one image recording device, including applying a number of measuring points to the road surface; recording images of the measuring points and the lighting devices of at least one additional measuring head using the image recording device of at least one measuring head and moving at least one measuring head to another position and/or in another spatial alignment. The steps of recording and moving are repeated several times. The spatial position of the road surface and the position of the lighting devices of the measuring heads are determined from the images recorded.

### CROSS REFERENCE

The present application claims the benefit under 35 U.S.C. §119 of German Patent Application No. DE 102010031056.5, filed on Jul. 7, 2010, which is expressly incorporated herein by reference in its entirety.

### FIELD OF THE INVENTION

The present invention relates to a method for calibrating a measuring system and a measuring station for video-based 3D measurement of a vehicle and a measuring station designed for performing a method according to the present invention.

### BACKGROUND INFORMATION

Video-based methods for chassis testing are available. German Patent Application Nos. DE 197 57 760 A1 and DE 100 32 356 A1 describe video-based methods for axial measurement; German Patent Application No. DE 199 49 982 C2 and European Patent No. EP 1 092 967 A2 describe video-based methods for chassis testing, in particular for testing the shock absorbers and brakes of a vehicle.

These methods have in common the fact that a vehicle is located on a road surface between two or four measuring heads, each being equipped with at least one video camera, and the measurement of the vehicle being performed on the basis of the images recorded by the video cameras.

To be able to perform such a measurement, the position of the measuring heads relative to one another and the position of the measuring heads in relation to the road surface on which the vehicle is standing must be known.

German Patent Application No. DE 10 2007 005 085 A1 describes a method and a device for aligning a vehicle ambient sensor or a headlight.

German Patent Application No. DE 10 2008 000 837 A1 describes a method for determining the relative position of two measuring heads in a video-based measuring system for measurement of the chassis. The method described therein requires very precise knowledge of the positions of the lighting units situated in the measuring heads with respect to the cameras of the measuring heads. German Patent Application No. DE 10 2008 000 837 A1 neither describes the determination of the position of the lighting units with respect to the cameras nor the determination of the position of the measuring heads with respect to the road surface.

### SUMMARY

An object of the present invention is to provide a method which permits a simple calibration of a video-based measuring system for measuring a vehicle and in particular the chassis of a vehicle with a high precision.

An example method according to the present invention for calibrating a measuring system and a measuring station for a chassis measurement, having a road surface, which is provided to place the vehicle to be measured on it, and having at least two measuring heads, each measuring head having at least one lighting device and at least one image recording device (camera), includes the following steps:

applying a number of measuring points to the road surface, the measuring points preferably being designed to be easily detectable by the image recording devices of the measuring heads;
recording images of the measuring points applied to the road surface and the lighting device(s) of at least one additional measuring head using the image recording device of at least one of the measuring heads;
moving at least one of the measuring heads to another position and/or in a different spatial alignment (orientation) at the measuring station;
repeating the steps of recording images of the measuring points and of the lighting device(s) and moving at least one measuring head, so that images of the measuring points and the lighting device(s) are recorded for a number of different positions or spatial alignments of at least one measuring head; and
determining the position of the road surface and the positions of the lighting devices of the measuring heads with respect to the image recording device from the images recorded.

An example measuring station according to the present invention for chassis measurement has a road surface, which is provided to place the vehicle to be measured thereon, at least two measuring heads, each being equipped with at least one lighting device and at least one image recording device and being movable on the measuring station, and an evaluation unit. The evaluation unit is designed for data transmission with the aid of the measuring heads and for performing an example method according to the present invention for calibration of the measuring station.

The example method according to the present invention and the example measuring station according to the present invention permit an accurate determination of the geometric position of the lighting devices and the position of the road surface with respect to the image recording devices of the measuring heads without requiring any additional technical equipment to perform the calibration.

The accuracy of the method increases with the number of measuring points and the number of different positions and alignments of the measuring heads from which images are recorded. The number of measuring points is preferably in the range of 1 to 20, and the number of different positions and alignments of the measuring heads is preferably in the range of 1 to 10.

It is not necessary to define or determine the position of the lighting devices with respect to the image recording devices, when manufacturing the measuring heads, to a high precision and constancy. The cost of manufacturing the measuring heads may therefore be reduced. Furthermore, the user may himself perform a renewed calibration of the measuring system without any great effort as needed, for example, after damage, misalignment or repairs.

In one specific embodiment, the position of the road surface and the position of the lighting devices of the measuring heads are determined using a photogrammetric method. The position of the road surface and the position of the lighting devices of the measuring heads may be determined with little effort and with a high precision by using a photogrammetric method.

In one specific embodiment of the method, images of the measuring points and the lighting device(s) of at least one measuring head are additionally recorded using at least one additional measuring head, this additional measuring head also being moved between different positions and/or alignments. By recording additional images using an additional measuring head, which is also moved to different positions or in different alignments, the accuracy of the calibration may be further improved.

In one specific embodiment, the measuring head is moved manually. A measuring station on which the measuring heads are moved manually is particularly simple and inexpensive to construct because mechanical devices for moving the measuring heads may be dispensed with.

In an alternative exemplary embodiment, the measuring heads are movable by motor. With motor-driven measuring heads, the calibration may be performed in a particularly convenient manner and automatically in particular.

In one specific embodiment, the method includes determining the optical focal distance and/or optical distortion of at least one of the image recording devices. The accuracy of the calibration is increased by using such a method, and user friendliness is improved because the optical focal distance and/or the optical distortion need not be taken into account manually.

Depending on the measuring method used for measuring the chassis, the image recording devices may be implemented as mono cameras, as stereo cameras or as multicamera systems.

The measuring points may be designed as spherical objects, e.g., golf or tennis balls, or as linear objects. The measuring points are preferably light reflecting or are designed as self-illuminating objects, so that they are easily detectable by the image recording devices.

The evaluation device may be connected by electric lines or wirelessly, e.g., by a radio or IR connection to the measuring heads in order to transmit measured data recorded and generated by measuring heads 6 to the evaluation device.

### BRIEF DESCRIPTION OF THE DRAWINGS

The present invention is explained in greater detail below on the basis of the figures.

FIG. 1 shows a schematic perspective view of a measuring station according to the present invention for the chassis measurement.

FIG. 2 shows a schematic top view of a measuring station according to the present invention.

FIG. 3 shows a schematic flow chart of a method according to the present invention.

### DETAILED DESCRIPTION OF EXAMPLE EMBODIMENTS

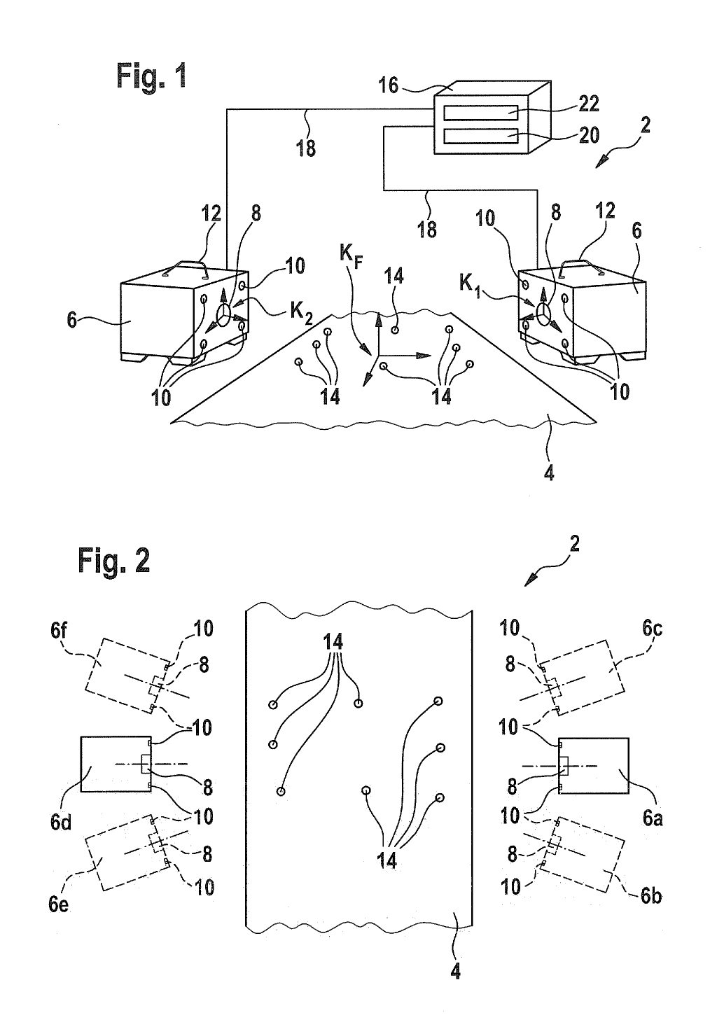

The exemplary embodiment of a measuring station 2 according to the present invention, shown in a schematic perspective view in FIG. 1, has a road surface 4 designed to receive a vehicle (not shown in FIG. 1), which is to be measured.

One measuring head 6 is situated on the left and another on the right of road surface 4. Each measuring head 6 has an image recording device (camera) 8 on the side facing road surface 4 and has a local coordinate system K₁, K₂, each assigned to appropriate image recording device 8, and four lighting devices 10 situated around image recording device 8.

For the chassis measurement, the vehicle to be measured is situated on road surface 4 in such a way that one measuring head 6 is situated on the left and another on the right side of the vehicle, lighting devices 10 each illuminates one side of the vehicle facing appropriate measuring head 6, and image recording devices 8 are able to record images of the side of the vehicle facing appropriate measuring head 6.

Measuring heads 6 shown in FIG. 1 are each provided with a carrying handle 12, making it possible to move measuring heads 6 manually to different positions on measuring station 2 and/or to alter the spatial alignment of measuring heads 6.

Several measuring points (targets) 14 designed to be easily detectable visually by image recording devices 8 of measuring heads 6 are situated on road surface 4. Measuring points 14 may be designed, for example, as illuminated or light-reflecting spheres, retro spheres or as simple inexpensive golf balls. Measuring points 14 form a measuring point field in a coordinate system F assigned to road surface 4.

FIG. 2 shows a schematic top view of an example measuring station 2 according to the present invention for a chassis measurement.

FIG. 2 shows measuring heads 6 in different possible positions 6a-6f and in different spatial alignments. To perform an example method according to the present invention, measuring heads 6 are moved to different positions 6a-6f on measuring station 2, the spatial alignment of measuring head 6 and in particular that of image recording devices 8 preferably being altered, as well. Images showing measuring points 14 applied to road surface 4 and/or lighting devices 10 of at least one measuring head 6 positioned on the opposite side of road surface 4 are recorded from the various positions and/or in different spatial alignments.

The spatial position of road surface 4 and the positions of lighting devices 10 of measuring heads 6 may be determined using the example method according to the present invention from these images recorded in various positions and/or in various alignments of image recording devices 8.

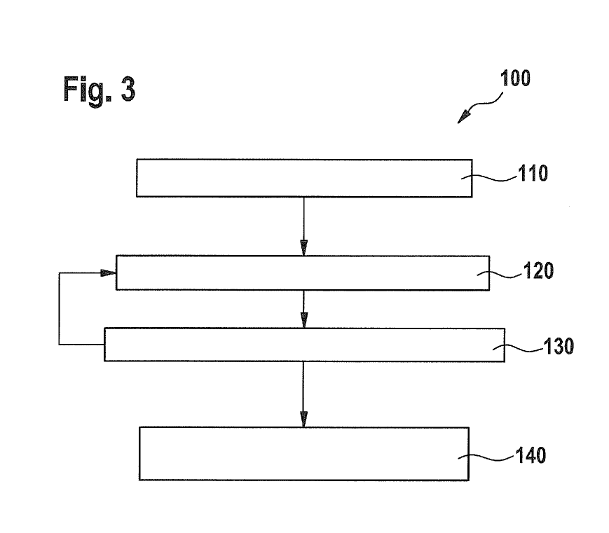

FIG. 3 shows a schematic flow chart 100, which describes the performance of an example method according to the present invention.

In a first step 110, measuring points (targets) 14 are distributed to various positions on road surface 4. The accuracy and complexity of the method increase with the number of measuring points 14 used. Preferably 10 to 20 measuring points 14 are applied to road surface 4.

In following step 120, several images of measuring points 14 and lighting devices 10 of at least one opposite measuring head 6 are recorded using image recording device 8 of at least one measuring head 6. Such images are preferably recorded using image recording device 8 of each measuring head 6 because the accuracy of the method increases with the number of images recorded from various angles of view.

In next step 130, the position and/or spatial alignment of at least one of measuring heads 6 is/are altered. This may be done manually by gripping relevant measuring head 6 by its carrying handle 12 and placing it in a new position in a new alignment within measuring station 2. Alternatively, measuring head 6 is moved by a motorized device, which is not shown in the figures.

After the spatial position and/or alignment of at least one of measuring heads 6 has been altered, step 120 of recording images of measuring point field 14 and of lighting devices 10 of at least one opposite measuring head 6 is repeated.

Steps 130 and 120 of altering the position and/or alignment of at least one measuring head 6 and recording images of measuring points 14 and lighting devices 10 of at least one opposite measuring head 6 are repeated as often as desired. The accuracy and complexity of the method increase with the number of repetitions. Preferably, images for five to fifteen different positions and alignments of measuring heads 6 are recorded.

After images have been recorded in the desired number of different positions and alignments of measuring heads 6, the recorded images are analyzed in step 140 for determining the spatial position of road surface 4 and of measuring heads 6.

During this process, the positions of measuring points 14 and lighting devices 10 of an opposite measuring head 6 are determined in the local coordinate system Kₒ (here o=1, 2) of appropriate measuring head 6 using the procedure described below. Local coordinate systems Kₒ of appropriate measuring heads 6 are defined by the position of the projection center and the optical axis of image recording device 8.

The transformation of a point x from a local coordinate system Kₒ into coordinate system F of road surface 4 may be described mathematically by

x_{F}=Rᵢx+tᵢ

where Rᵢ is a 3×3 rotation matrix for describing a rotation and tᵢ is a 3×1 translation vector, which describes the translation between two coordinate systems Kₒ, F. The i=1 . . . n measurements from the various positions and alignments of measuring heads 6 supply 2×1 vectors of image coordinates x′ₖᵢ of the position of k=1 . . . m lighting devices 10 and image coordinates x′ⱼᵢ of j=1 . . . p measuring points 14 from the image recorded using appropriate image recording device 8.

With the least squares method, which is from photogrammetry (see, for example, Thomas Luhmann “Nahbereichsphotogrammetrie: Grundlagen, Methoden und Anwendungen” [Close-Range Photogrammetry: Principles, Methods and Applications]), published by Wichmann Verlag, parameters R₁ᵢ, t₁ᵢ, R₂ᵢ, t₁ᵢ, xₖ and xⱼ may be determined by optimization:

$${\sum }_{i , k} {[ {x}_{1 ki}^{′} - {f}_{2} ( I O {R}_{1} , {R}_{1 i} , {t}_{1 i} , {R}_{2 i} , {t}_{2 i} , {x}_{k} ) ]}^{2} + {\sum }_{i , k} {[ {x}_{2 ki}^{′} - {f}_{2} ( I O {R}_{1} , {R}_{1 i} , {t}_{1 i} , {R}_{2 i} , {t}_{2 i} , {x}_{k} ) ]}^{2} + {\sum }_{i , j} {[ {x}_{1 ji}^{′} - {f}_{1} ( I O {R}_{1} , {R}_{1 i} , {t}_{1 i} , {x}_{j} ) ]}^{2} + {\sum }_{i , j} {[ {x}_{2 ji}^{′} - {f}_{1} ( I O {R}_{2 i} , {R}_{2 i} , {t}_{1 i} , {x}_{j} ) ]}^{2} -> min$$

where function fₗ describes the imaging of an object point xⱼ from measuring point field 14 of road surface 4 using coordinate transformation R₁ᵢ, t₁ᵢ of first measuring head 6 at site i in one image coordinate x′₁ⱼᵢ and, similarly, the imaging of an object point xⱼ using coordinate transformation R₂ᵢ, t₂ᵢ of second measuring head 6 at site i in an image coordinate x′₂ⱼᵢ.

Function f₂ describes the imaging of coordinate xₖ of punctiform lighting device 10 of coordinate system K₂ of second measuring head 6 by successive execution of geometric transformation R₂ᵢ, t₂ᵢ of the point into coordinate system F, subsequent transformation R₁ᵢ, t₁ᵢ in coordinate system K₁ and of projection into image recording device 8 of first measuring head 6 in image coordinate x′₁ₖᵢ. Similarly, function f₂ also describes the imaging of coordinate xₖ of punctiform lighting device 10 of coordinate system K₁ of first measuring head 6 by successive execution of geometric transformations R₁ᵢ, t₁ᵢ and R₂ᵢ, t₂ᵢ into coordinate system K₂ and of projection into image recording device 8 of second measuring head 6 in image coordinate x′₂ₖᵢ.

Intrinsic parameters IOR₁ and IOR₂ of functions f₁ and f₂ describe optical imaging in appropriate image recording device 8 and include, among other things, the focal distance and a possibly present optical distortion. If these parameters are not already known, they may also be determined as part of the calibration.

Image recording devices 8 may be monocamera, stereo camera or multicamera systems. Using a method according to the present invention, the position of lighting devices 10 and the position of road surface 4 may be determined with a high accuracy with respect to image recording devices 8 of measuring heads 6 in a simple process, not requiring any additional technical equipment except for measuring points 14. In particular the accuracy of the method may be adjusted as needed by choosing the number of measuring points 14 used and the number of different positions, where measuring heads 6 are moved for recording the image.

What is claimed is:

1. A method for calibrating a measuring station for a vehicle measurement, the measuring station having a road surface and at least two measuring heads, each measuring head having at least one lighting device and at least one image recording device, the method comprising:
a) applying a number of measuring points to the road surface;
b) recording images of the measuring points and of at least one lighting device of at least one additional measuring head with the aid of the image recording device of at least one measuring head;
c) moving at least one measuring head to at least one of another position and to an altered spatial alignment within the measuring station;
d) repeating steps b) and c); and
e) determining a spatial position of the road surface and the lighting devices of the measuring heads from the images recorded in step b).

2. The method as recited in claim 1, wherein the determination of the spatial position of the road surface and of the lighting devices of the measuring heads includes performing a photogrammetric method.

3. The method as recited in claim 1, wherein steps b) through d) are additionally performed using at least one additional measuring head.

4. The method as recited in claim 1, wherein the measuring head is moved manually in step c).

5. The method as recited in claim 1, wherein the measuring head is moved by motor in step c).

6. The method as recited in claim 1, further comprising:
determining at least one of an optical focal distance and an optical distortion of at least one of the image recording devices.

7. The method as recited in claim 1, wherein the image recording devices are one of monocameras, stereo cameras, or multicamera systems.

8. The method as recited in claim 1, wherein the measuring points are one of spherical objects or as linear objects.

9. The method as recited in claim 1, wherein the measuring points are one of light-reflecting objects or self-illuminating objects.

10. A measuring station for a chassis measurement, comprising:
a road surface;
at least two measuring heads, each measuring head having at least one lighting device and at least one image recording device and being movable on the measuring station; and
an evaluation device for data transmission via the measuring heads and configured to performing a method for calibrating the measuring station, the method including:
a) applying a number of measuring points to the road surface,
b) recording images of the measuring points and of at least one lighting device of at least one additional measuring head with the aid of the image recording device of at least one measuring head,
c) moving at least one measuring head to at least one of another position and to an altered spatial alignment within the measuring station,
d) repeating steps b) and c), and
e) determining a spatial position of the road surface and the lighting devices of the measuring heads from the images recorded in step b).
